(19) United States
(12) Patent Application Publication
(10) Pub. No.: US 2019/0283656 A1
(43) Pub. Date: Sep. 19, 2019

(54) Side Slide Stud Bracket

(71) Applicants: Andrew Visinski, Seymour, CT (US); Josef Visinski, Shelton, CT (US)

(72) Inventors: Andrew Visinski, Seymour, CT (US); Josef Visinski, Shelton, CT (US)

(21) Appl. No.: 15/925,064

(22) Filed: Mar. 19, 2018

(51) Int. Cl. B60P 7/14; B61D 45/00; B60P 7/08

(52) U.S. Cl. CPC B60P 7/14; B60P 7/0815; B61D 45/001

(57) ABSTRACT

A vehicle accessory device in the form of a side slide stud bracket that can be used in conjunction with existing board holder pocket/stud cargo securing systems to afford the user greater flexibility in securing his or her cargo load by more closely matching the dimensions of the cargo securing system to the dimensions of the cargo being transported. The bracket of the present invention is repositionable, does not require the use of external tools to install, reposition or remove, and reduces the likelihood that the cargo will slide or tip over during transport.

### FIELD OF THE INVENTION

This invention relates to an accessory for vehicles and, more specifically vehicles with beds or cargo compartments.

### BACKGROUND

In general, the cargo storage compartment associated with both pick-up trucks and some closed top vehicles, such as vans, are designed to provide as much room for cargo storage as possible. To facilitate the handling of cargo, many vehicles such as truck beds have features which stabilize and control shifting of cargo in the truck bed during transportation. For example, board holder pockets or supports have been used for a number of years to support boards horizontally to prevent shifting of cargo in a truck bed or other vehicle cargo space. More specifically, a user would place each end of a board or stud, such as a 2″×6″, into opposing board holder supports to partition a truck bed or other cargo space to more closely match the dimensions of the cargo load and to reduce or limit the movement of the cargo during transport.

Unfortunately, one limitation of the board holder pocket/stud cargo securing system is that the board holders are often times formed into the truck bed or bed liner and are, therefore, stationary and afford the user with no ability to reposition the same. Stated differently, the most that the user can do is position a board or stud between said opposing board holder pockets in their preexisting position to partition a portion of the truck bed. However, if the dimensions of the partition do not match the dimensions of the cargo being transported, said cargo has a tendency to slide within the confines of the partition or tip over, both of which are undesirable.

Consequently, there is a long felt need in the art for a vehicle accessory device that can be used in conjunction with existing board holder pocket/stud cargo securing systems to afford the user greater flexibility in securing his or her cargo load by more closely matching the dimensions of the partitioned cargo space to the dimensions of the cargo being transported. There is also a long felt need in the art for an accessory that reduces the likelihood that the cargo will slide or tip over during transport, and that is quickly and easily repositionable. Finally, there is a long felt need in the art for a vehicle accessory device that accomplishes all of the forgoing objectives, and that is relatively inexpensive to manufacture and safe and easy to use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed herein, in one aspect thereof, is a vehicle accessory device in the form of a side slide stud bracket that: (i) affords the user greater flexibility in securing his or her cargo load by allowing the user to more closely match the dimensions of the cargo securing system with the dimensions of the cargo being transported; (ii) is easily repositionable and reduces the likelihood that the cargo will slide or tip over during transport; and (iii) is relatively inexpensive to manufacture and safe and easy to use.

In a preferred embodiment of the present invention, the side slide stud bracket comprises a bracket portion and an arm extending outwardly from said bracket portion, as described more fully below. The repositionable side slide stud bracket of the present invention, when used in connection with existing cargo securing systems, accomplishes all of the forgoing objectives, as well as others, and is relatively inexpensive to manufacture and safe and easy to use.

A cargo securing system for use with a pick-up truck or other cargo transportation vehicle and a method of using the same are also disclosed herein. Said cargo securing system preferably comprises a pair of opposing and spaced apart board holder pockets, a board or a stud extending between and removably attached to said board holder pockets, and a side slide stud bracket. The side slide stud bracket may further comprise a bracket portion, an arm extending outwardly from said bracket portion, and a fastener, as described more fully below.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 is a perspective view of the side slide stud bracket of the present invention.

FIG. 2A is a side perspective view of an alternative embodiment of the side slide stud bracket of the present invention in an extended position.

FIG. 2B is a side perspective view of an alternative embodiment of the side slide stud bracket of the present invention in a contracted position.

FIG. 3 is a perspective view of the side slide stud bracket of the present invention secured to a stud and securing a gas can in a truck bed.

FIG. 4 is a perspective view of a pair of side slide stud brackets of the present invention secured to a stud, with one of said side slide stud brackets securing a gas can in a truck bed.

FIG. 5 is a perspective view of a cargo securing system of the present invention.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

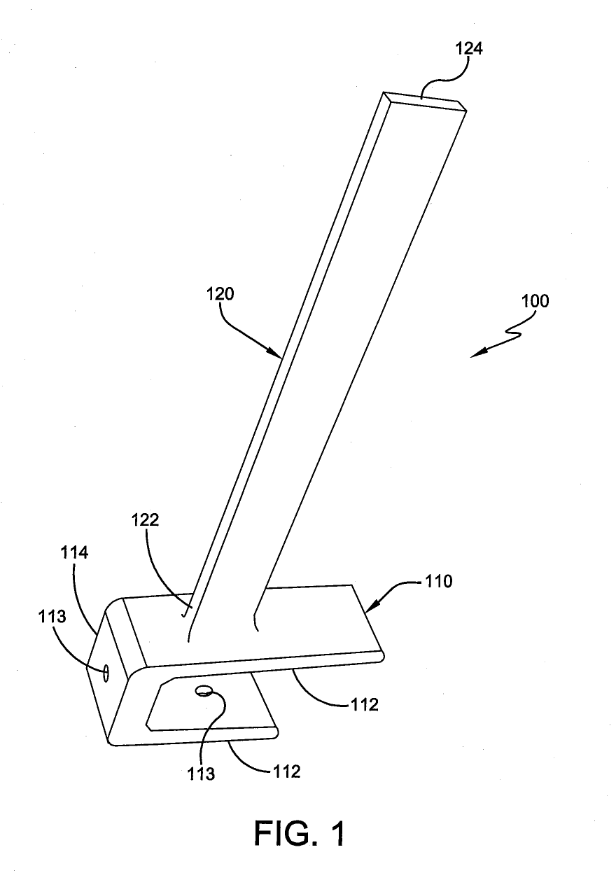

Referring initially to the drawings, FIG. 1 is a perspective view of one embodiment of the side slide stud bracket 100 of the present invention. Bracket 100 is preferably comprised of a bracket portion 110 and an arm portion 120, and may be formed of any durable material commonly known in the art, such as steel, iron, aluminum, plastic or other composite material. Ideally, bracket 100 would be formed of a weather resistant material, such as plastic or aluminum, so that it is not subject to corrosion or deterioration when exposed to the elements, such as rain, snow, sleet, etc., or salt from the roadway.

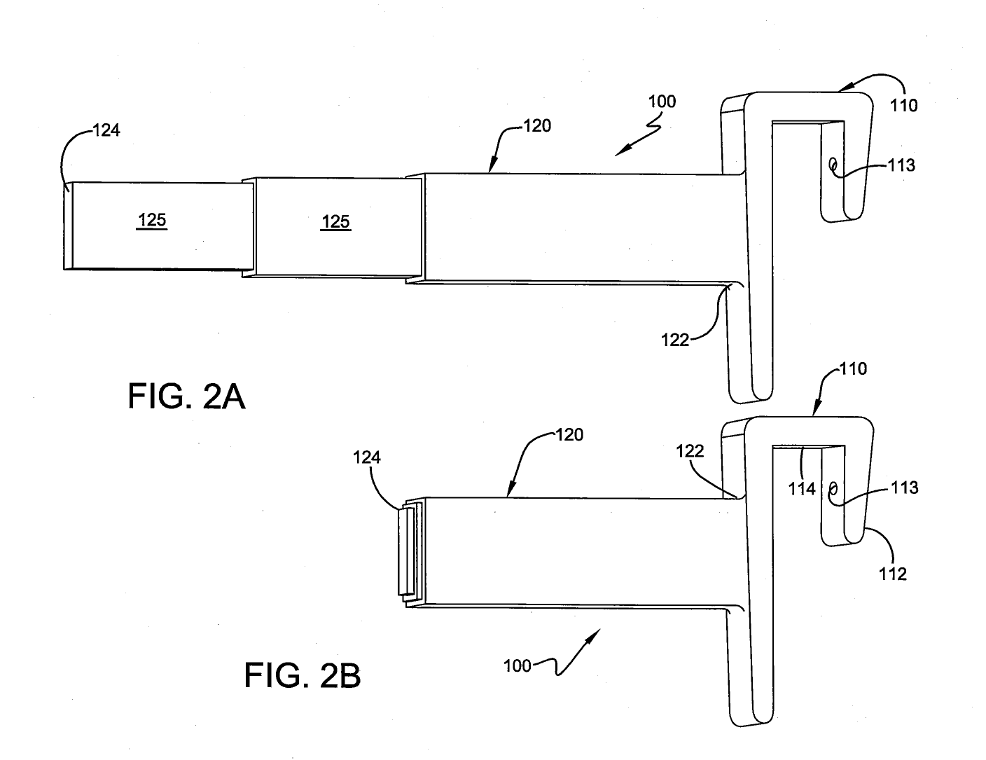

Bracket portion 110 is generally U-shaped and comprised of a pair of opposing and spaced apart legs 112 connected by a middle portion 114. Legs 112 can be of similar size and shape, or one leg 112 may be larger or smaller than the other, as shown in FIGS. 1-2. One or both of legs 112 and/or middle portion 114 may further comprise an opening 113 therein for receipt of a fastener (not shown), which can be used to further secure bracket 100 to a stud, as described more fully below. Additionally, legs 112 are typically spaced apart between 1½ and 1⅝″ to receive a stud, such as a 2″×4″, 2″×6″ or 2″×8″, all of which typically have a thickness of approximately 1½″. Notwithstanding, it is contemplated that bracket 100, and its various components, may come in other shapes and sizes to accommodate user preference.

Arm portion 120 is preferably an elongated member having a first or inboard end 122 that is attached to, or integrally formed with, one of legs 112, and an opposing, cantilevered second end 224. Arm portion 120 can vary in length, thickness, width and shape to suit user preference. For example, it may be desirable for arm portion 120 to extend from bracket portion 110 to one of the following: truck cab (not shown); truck tailgate (not shown) or a second stud (not shown) positioned elsewhere in the truck bed 160.

FIG. 2A is a perspective side view of an alternative embodiment of the side slide stud bracket 100 of the present invention in an extended position and FIG. 2B is a perspective side view of an alternative embodiment of the side slide stud bracket 100 of the present invention in a contracted position. The only difference between the side slide bracket of FIG. 1 and that which is shown in FIGS. 2A and B is that arm portion 120 is comprised of telescoping sections 125 that can be extended or contracted to adjust the overall length of arm portion 120 to suit user preference.

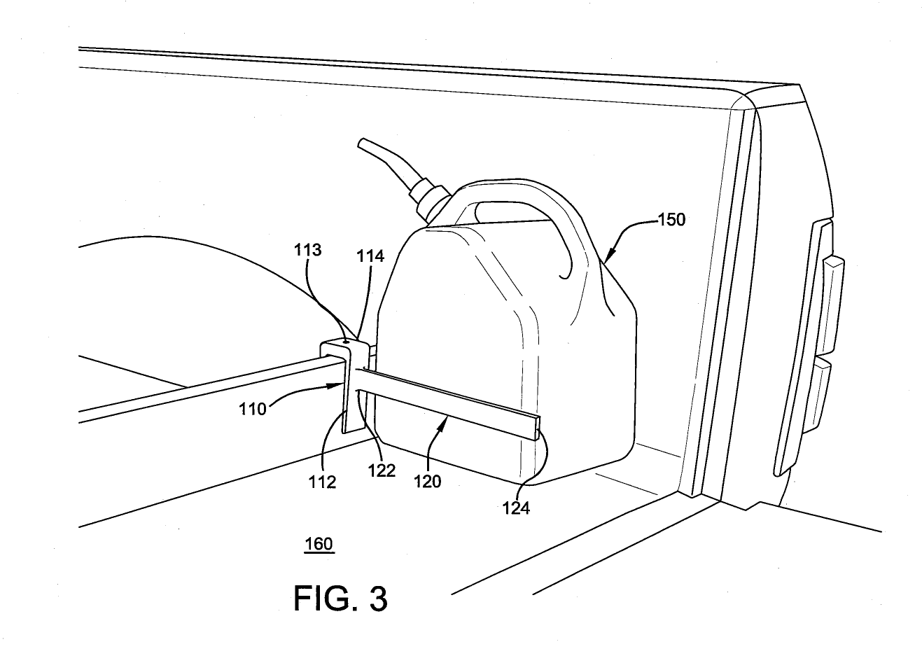

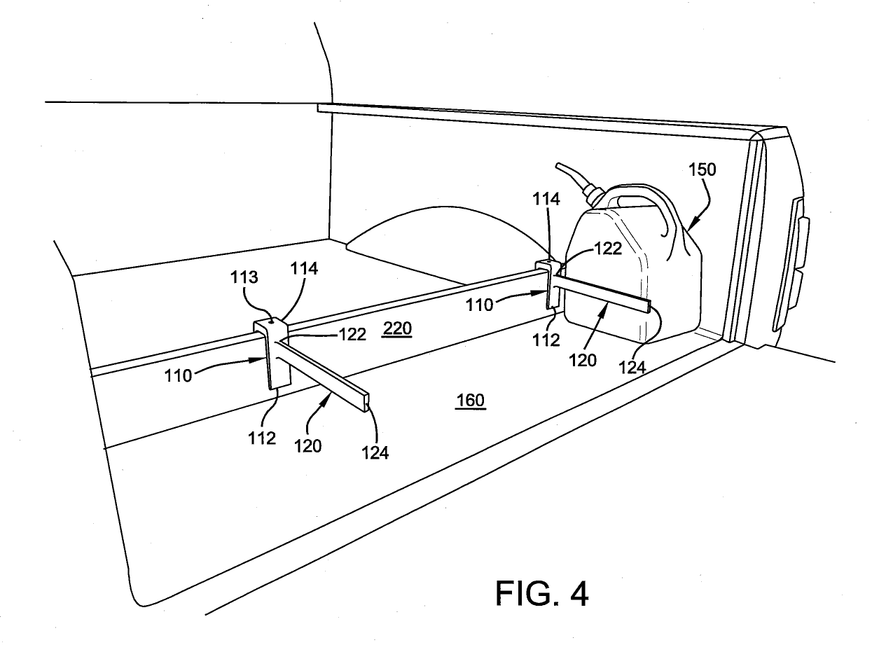

FIG. 3 is a perspective view of side slide stud bracket 100 secured to a stud 220 and securing a cargo (i.e., a gas can) 150 in a truck bed 160, and FIG. 4 is a perspective view of a pair of side slide stud brackets 100 secured to a stud 220, with one of said side slide stud brackets 100 securing a gas can (i.e., cargo) 150 in a truck bed 160.

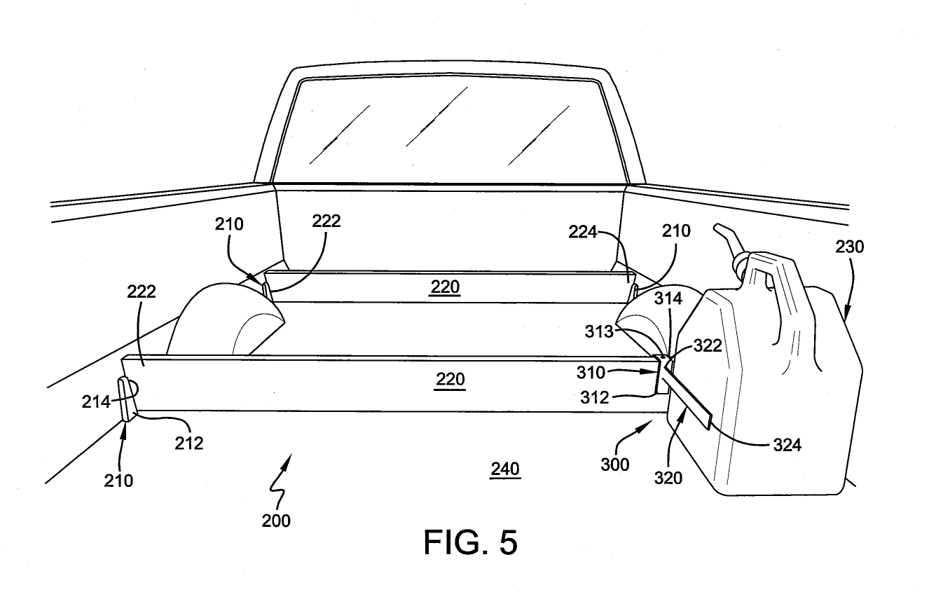

FIG. 5 is a perspective view of a cargo securing system 200 of the present invention. Cargo securing system 200 is comprised of a pair of stud pocket holders 210, a stud 220 and one or more side slide stud brackets 300. Said pair of stud pocket holders 210 are spaced apart and typically molded into the sides of a truck bed or bed liner for receipt of stud 220. Each of said pair of stud pocket holders 210 typically comprise a base 212 and a slot or other opening 214 for receipt of one end of said stud 220.

Stud 220 can be any stud or elongated member commonly known in the art and is comprised of a first end 222 and a second end 224, wherein said stud 220 extends across the width of the truck bed 240 and is removably attached to the pair of stud pocket holders 210. For example, stud 220 can be a 2″×4″, 2″×6″ or 2″×8″, all of which typically have a thickness of approximately 1½″, and a length that extends across the width of the truck bed 240. Stud 220 can be formed of any durable material known in the art such as wood, metal, plastic, etc., but is preferably constructed of a material that is softer than the material that comprises side slide stud bracket 100. However, if stud 220 is constructed of wood, pretreated lumber should be used to preserve stud 220 from the elements such as rain, snow, sleet, etc., or salt from the roadway.

As described above, side slide bracket 300 is preferably comprised of a bracket portion 310 and an arm portion 320, and may be formed of any durable material commonly known in the art, such as steel, iron, aluminum, plastic or other composite material. Ideally, bracket 300 would be formed of a weather resistant material, such as plastic or aluminum, so that it is not subject to corrosion or deterioration when exposed to the elements, such as rain, snow, sleet, etc., or salt from the roadway.

Bracket portion 310 is generally U-shaped and comprised of a pair of opposing and spaced apart legs 312 connected by a middle portion 314. Legs 312 can be of similar size and shape, or one leg 312 may be larger or smaller than the other. One or both of legs 312 and/or middle portion 314 may further comprise an opening 313 therein for receipt of a fastener (not shown), which can be used to further secure bracket 300 to stud 220, as described more fully below. Additionally, legs 312 are typically spaced apart between 1½ and 1⅝″ to receive a stud, such as a 2″×4″, 2″×6″ or 2″×8″, all of which typically have a thickness of approximately 1½″. Notwithstanding, it is contemplated that bracket 300, and its various components, may come in other shapes and sizes to accommodate user preference.

Arm portion 320 is preferably an elongated member having a first or inboard end 322 that is attached to, or integrally formed with, one of legs 312, and an opposing, cantilevered second end 324. Arm portion 320 can vary in length, thickness, width and shape to suit user preference. For example, it may be desirable for arm portion 320 to extend from bracket portion 310 to one of the following: truck cab (not shown); truck tailgate (not shown) or a second stud 220 positioned elsewhere in the truck bed 360. It is also contemplated that arm portion can be telescoping so that its overall length could be adjusted to suit user preference.

Having now described the general structure of a preferred embodiment of side slide stud brackets 100, 300 and cargo securing system 200, their function will now be described in general terms and in relation to FIG. 5. A user (not shown) desiring to more closely match the dimensions of his/her cargo space in, for example, a truck bed 240 to the dimensions of the cargo 230 to be transported can utilize the cargo securing system 200 of the present invention by removably attaching an appropriate sized stud 220 to the pair of opposing stud pocket holders 210 to partially partition the truck bed 240. The user can then further partition truck bed 240 by removably and repositionably attaching one or more side slide stud brackets 300 to said stud 220. More specifically, brackets 300 can be positioned at a desired location along said stud 220 (preferably adjacent to the cargo 230 being transported) by placing the generally U-shaped bracket portion 310 over stud 220. The weight and the friction fit of the bracket 300 in relation to stud 220 will secure the bracket 300 to stud 220 and the cargo 230 within the twice partitioned truck bed 240. Further, as lateral loads are applied to arm portion 320 (e.g., by the cargo 230 being secured thereby), bracket portion 310 pinches, or applies pressure to, stud 220 thereby preventing bracket 300 from sliding along stud 220. This is one reason why it is preferable for stud 220 to be comprised of a material that is softer than bracket 300. Nonetheless, if additional security is desired or needed, a fastener (not shown), such as a screw, can be inserted into opening 313 in bracket portion 310 and into stud 220 to further secure bracket 300 to stud 220.

In a further preferred embodiment of the present invention, arm portion 320 may be telescoping and extend all the way from bracket portion 310 to, for example, the truck cab (not shown), the truck tailgate (not shown) or a second stud 220 positioned elsewhere in truck bed 240.

Other variations are also within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A side slide stud bracket comprising:
a bracket portion; and
an arm portion, wherein said arm portion extends outwardly from said bracket portion.

2. The bracket of claim 1, wherein said bracket portion is comprised of a pair of substantially parallel and spaced apart legs that are separated by, and connected to, a middle portion.

3. The bracket of claim 1, wherein said bracket portion is further comprised of at least one opening.

4. The bracket of claim 3 further comprised of a fastener for insertion into said opening to secure the bracket to an object.

5. The bracket of claim 1, wherein said arm portion is telescoping.

6. The bracket of claim 2, wherein one of said pair of legs is longer than the other of said pair of legs.

7. The bracket of claim 1, wherein aid arm portion is integrally formed with said bracket portion.

8. A cargo securing system for a vehicle comprising:
a pair of stud pocket holders;
a stud; and
a side slide stud bracket.

9. The cargo securing system of claim 8, wherein each of said pair of stud pocket holders further comprise a base portion and a slot for receipt of said stud.

10. The cargo securing system of claim 8, wherein said pair of stud pocket holders are spaced apart and said stud extends between, and is removably attached to, each of said pair of stud pocket holders.

11. The cargo securing system of claim 8, wherein said side slide stud bracket comprises a bracket portion and an arm portion, and further wherein said arm portion extends outwardly from said bracket portion.

12. The cargo securing system of claim 11, wherein said bracket portion is comprised of a pair of substantially parallel and spaced apart legs that are separated by, and connected to, a middle portion.

13. The cargo securing system of claim 11, wherein said bracket portion is comprised of at least one opening and further wherein said cargo securing system further comprises a second side slide stud bracket.

14. The cargo securing system of claim 11, wherein aid arm portion is integrally formed with said bracket portion and is telescoping.

15. A method of securing a cargo in a truck bed comprising the steps of:
providing a pair of spaced apart stud pocket holders;
extending a stud between said pair of spaced apart stud pocket holders; and
attaching a side slide stud bracket to said stud.

16. The method of claim 15, wherein said side slide stud bracket is comprised of a bracket portion and an arm portion, and further wherein said arm portion extends outwardly from said bracket portion.

17. The method of claim 15, wherein said pair of spaced apart stud pocket holders are attached to said truck bed.

18. The method of claim 15, wherein said stud is removably secured to each of said pair of spaced apart stud pocket holders.

19. The method of claim 15, wherein said side slide stud bracket is repositionable along a length of said stud without external tools.

20. The method of claim 16, wherein said bracket portion is comprised of a pair of substantially parallel and spaced apart legs, and further wherein one of said legs is longer than the other of said legs.
